(19) United States
(12) Patent Application Publication
(10) Pub. No.: US 2017/0016222 A1
(43) Pub. Date: Jan. 19, 2017

(54) AUTO-CLEANING DEVICE FOR TOILET

(71) Applicant: Junqi DIAO, Shandong (CN)

(72) Inventor: Junqi DIAO, Shandong (CN)

(21) Appl. No.: 15/123,710

(22) PCT Filed: Dec. 11, 2014
(86) PCT No.: PCT/CN2014/093556

§ 371 Date: Sep. 6, 2016

(30) Foreign Application Priority Data
Mar. 20, 2014 (CN) 201420126642.1
Apr. 21, 2014 (CN) 201420192878.5
Sep. 25, 2014 (CN) 201420554396.X

(51) Int. Cl. E03D 9/00; E03D 1/32; E03D 1/14; E03D 1/34; E03D 9/04; E03D 5/10; E03D 1/36

(52) U.S. Cl. CPC E03D 9/002; E03D 5/10; E03D 1/32; E03D 1/36; E03D 1/34; E03D 9/04; E03D 1/142; F16K 31/0675

(57) ABSTRACT

An auto-cleaning device for a toilet includes a water inlet module, a water flushing module and a deodorization module, and also includes a power supply module, and a control circuit used for automatically starting the water flushing module and the deodorization module and controlling the water flushing time. The control circuit includes a toilet bowl operation starting circuit, a deodorization starting circuit, a water flushing mode selection circuit used for determining the water flushing time, and a water flushing starting circuit.

### TECHNICAL FIELD

The present invention relates to a cleaning device, specifically an auto-cleaning device for toilet.

### BACKGROUND TECHNOLOGY

When people use toilets, human excrement usually produce lots of stink and bacteria, and such stink will cause hazards to human body to different extent after being inhaled by human body. After finishing the use of toilets, people need manually pressing the flushing and deodorization buttons, and in such operations, people are liable to contact various bacteria; in case some users forget flushing and deodorization, and that will cause inconvenience to other users. It is not easy to control the water flushing time and amount of water for flushing, and in order to flush cleanly, people have no choice but to flush repeatedly, which is both fussy and time-wasting, and also goes against water conservation. At present, deodorization is mainly aimed at the stink from excrement spreading all over toilets, while sewers are not purified, so the deodorization is not thorough. In addition, the flushing equipment and deodorization equipment in toilets need separate power supply, which goes against energy conservation. Since toilets belong to humid environment, it is hard to control electrical safety, and thus it is liable to cause electric shock to users.

### CONTENT OF INVENTION

Targeted at the aforesaid problems, the present invention provides an auto-cleaning device for toilet which can realize automatic power generation, water flushing for deodorization, controllable water flushing and thorough deodorization.

In order to solve the aforesaid problems, the present invention adopts the technical solution: an auto-cleaning device for toilet, comprising a water inlet module, a water flushing module and a deodorization module, and further comprising a power supply module, and a control circuit which is used for automatically starting the water flushing module and the deodorization module and controlling the water flushing time. The said control circuit comprises a toilet bowl operation starting circuit, a deodorization starting circuit, a water flushing mode selection circuit which is used for determining the water flushing time, and a water flushing starting circuit. The water flushing module and deodorization module automatically start through the control circuit, and the water flushing time is selected after faeces and piss are automatically distinguished based on time, saving time and labor and being conductive to water conservation.

The said water inlet module is arranged inside the toilet water tank, consisting of a water inlet pipe, a water replenishing pipe and a bistable solenoid valve, wherein the upper end of water replenishing pipe is connected with the toilet water tank, while the lower end is connected with the water inlet pipe by the bistable solenoid valve. Water flows from the water inlet pipe into the water replenishing pipe to replenish water for the toilet water tank.

The said water flushing module is arranged inside the toilet water tank, consisting of a water flushing pipe, an air exhaust pipe and a water flushing valve, wherein the water flushing valve is installed inside the water flushing pipe, and one end of the air exhaust pipe is installed below the water flushing valve and connected with the water flushing pipe, while the other end is connected with the deodorization module. The connecting end of air exhaust pipe and deodorization module has an overflow hole connected with the toilet water tank. On the one hand, during the deodorization and sterilization process, the air in space of toilet water tank can partly participate in deodorization circulation through the overflow hole; on the other hand, when the water level of water tank is too high in some extreme cases, the water in water tank will flow into toilet from the overflow hole, avoid overflowing on the floor of toilet.

The said power supply module comprises a storage battery, an electronic voltage stabilizer, a hydroelectric generator installed above the bistable solenoid valve and an external photovoltaic cell panel, wherein the hydroelectric generator and photovoltaic cell panel are connected to the electronic voltage stabilizer, and connected with the storage battery through the electronic voltage stabilizer. The power supply of storage battery is set as 24V and below DC safety voltage, during the replenishing process of toilet water tank, when water flows through the hydroelectric generator, the hydroelectric generator will generate power under the driving of water flow pressure, and the unstable voltage from the hydroelectric generator will charge the storage battery after voltage stabilization via the electronic voltage stabilizer. The said photovoltaic cell panel is A-Si photovoltaic cell panel. When the photovoltaic cell panel receives illumination of light, it will convert light energy into electric energy, charging the storage battery after voltage stabilization via the electronic voltage stabilizer, and the storage battery will charge the water flushing module and deodorization module.

The said deodorization module comprises an air purification module and an air exhauster, wherein the said air purification module comprises one or the combination of active carbon, low temperature catalyst and ozone generator.

In order to make ozone both react with active carbon and low temperature catalyst and dissolved in water of water tank, wherein the said ozone generator is connected with the air purification module, while the said ozone generator is connected with the toilet water tank via the pipe connected with the air pump. The ozone from the ozone generator is pumped into the water tank via the pipe by the air pump, increasing the ozone content and improving the deodorization effect, purifying the air of toilet and the sewer.

The said device operation starting circuit is composed of toilet cover position switch SP, human body induction switch SQ and coil of operating relay KM connected in series. Under the condition that two conditions that the toilet cover is open and persons are near the toilet are met, the coil of operating relay KM is energized and will start the purification device.

The said deodorization starting circuit is composed of the normal open contact of operating relay KM and the coil of deodorization relay KM1 connected in series.

The said water flushing mode selection circuit is connected with the coil of deodorization relay KM1 in parallel, consisting of three parallel branches, the first branch is the coil of power-on delay relay KT used for determining water flushing mode; the second branch is composed of the normal closed contact of power-on delay relay KT and the coil of small water flushing power-off delay relay KT1 connected in series; the third branch is composed of the normal open contact of power-on delay relay KT and the coil of large water flushing power-off delay relay KT2 connected in series.

The said water flushing starting circuit is as follows: firstly, series circuit is composed of the normal closed contact of operating relay KM and the coil of water flushing relay KM2 connected in series; secondly, parallel circuit is composed of the normal open contact of small water flushing power-off delay relay KT1 and the normal open contact of large water flushing power-off delay relay KT2 connected in parallel; thirdly, the said water flushing starting circuit is composed of the aforesaid series circuit and the aforesaid parallel circuit connected in series.

The said toilet cover position switch SP is a normally open angle switch; the said human body induction switch SQ is a normally open travel switch. When the angle formed by toilet cover and toilet seat reaches a certain value, the normally open angle switch will be closed, and when a person is near the human body induction switch SQ, the normally open contact will be closed, and when both are closed, the power supply module will be connected.

The present invention charges the storage battery through the A-Si solar panel and hydroelectric generator, and then supplies other modules with power, not only saving energy, but ensuring the electricity safety in humid environment. In addition, the present invention can prevent people from contact various bacteria and select water flushing time based on faeces and piss through the control circuit, automatic starting of water flushing module and deodorization module and controlling the water flushing time, not only ensuring thoroughly flushing but saving water, purifying the sewer at the time of removing stink of toilet, making deodorization more thoroughly and reducing the harm of stink and bacteria to users' body.

### DESCRIPTION OF FIGURES

FIG. 1 is the structure diagram of Embodiment 1;

FIG. 2 is the control circuit diagram of Embodiment 1;

FIG. 3 is the structure diagram of Embodiment 2;

FIG. 4 is the control circuit diagram of Embodiment 2;

Where, 1. Bistable solenoid valve, 2. Hydroelectric generator, 3. Water replenishing pipe, 4. Toilet water tank, 5. Photovoltaic cell panel, 6. Electronic voltage stabilizer, 7. Storage battery, 8. Water flushing valve, 9. Water flushing pipe, 10. Air exhaust pipe, 11. Overflow hole, 12. Air pump, 13. Ozone generator, 14. Low temperature catalyst, 15. Air exhauster, 16. Active carbon, 17. Water inlet pipe, 18. Water outlet pipe.

### SPECIFIC EMBODIMENTS

### Embodiment 1

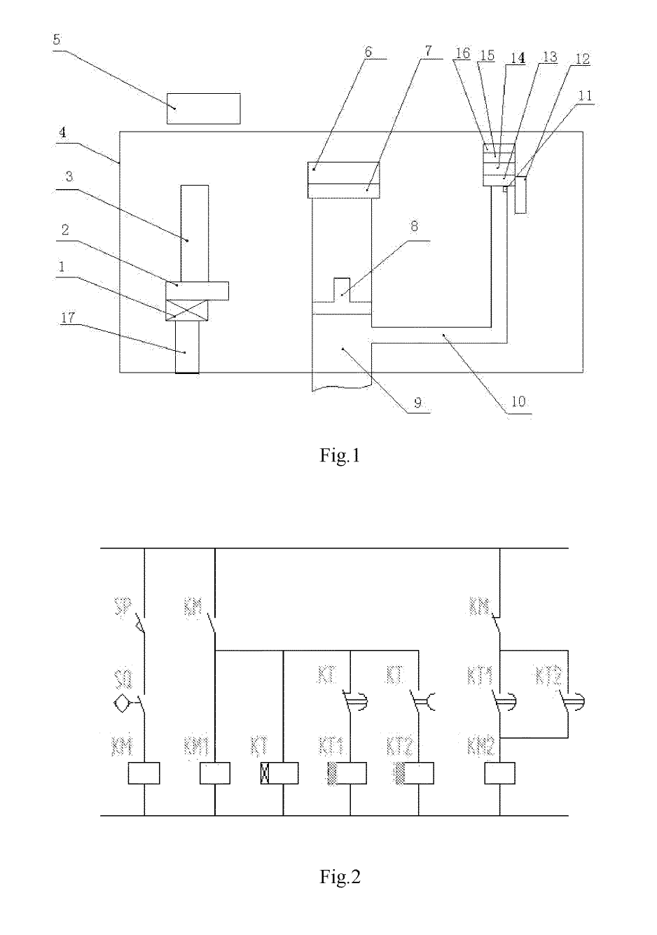

As shown in FIG. 1, an auto-cleaning device for toilet, mainly used for pedestal pan, comprising a water inlet module, a water flushing module and a deodorization module, and further comprising a power supply module, and a control circuit which is used for automatically starting the water flushing module and the deodorization module and controlling the water flushing time. The said water inlet module is arranged inside the toilet water tank 4, consisting of water inlet pipe 17, water replenishing pipe 3 and bistable solenoid valve 1, wherein the upper end of water replenishing pipe 3 is connected with the toilet water tank 4, while the lower end is connected with the water inlet pipe 17 by the bistable solenoid valve 1. The said water flushing module is arranged inside the toilet water tank 4, consisting of a water flushing pipe 9, an air exhaust pipe 10 and a water flushing valve 8, wherein the water flushing valve 8 is installed inside the water flushing pipe 9, and one end of the air exhaust pipe 10 is installed below the water flushing valve 8 and connected with the water flushing pipe 9, while the other end is connected with the deodorization module. The said power supply module comprises a storage battery 7, an electronic voltage stabilizer 6, a hydroelectric generator 2 installed above the bistable solenoid valve 1 and an external photovoltaic cell panel 5, wherein the hydroelectric generator 2 and photovoltaic cell panel 5 are connected to the electronic voltage stabilizer 6, and connected with the storage battery 7 through the electronic voltage stabilizer 6. The said deodorization module comprises an air purification module and an air exhauster 15, wherein the said air purification module comprises one or the combination of active carbon 16, low temperature catalyst 14 and ozone generator 13. The said ozone generator 13 is connected with the air purification module, while the said ozone generator is connected with the toilet water tank 4 via the pipe connected with the air pump 12.

As shown in FIG. 2, the said control circuit comprises a device operation starting circuit, a deodorization starting circuit, a water flushing mode selection circuit which is used for determining the water flushing time, and a water flushing starting circuit. The said device operation starting circuit is composed of toilet cover position switch SP, human body induction switch SQ and coil of operating relay KM connected in series. The said deodorization starting circuit is composed of the normal open contact of operating relay KM and the coil of deodorization relay KM1 connected in series. The said water flushing mode selection circuit is connected with the coil of deodorization relay KM1 in parallel, and the water flushing mode selection circuit is composed of three parallel branches. The first branch is the coil of power-on delay relay KT used for determining water flushing mode; the second branch is composed of the normally closed contact of power-on delay relay KT and the coil of small water flushing power-off delay relay KT1 connected in series; the third branch is composed of the normally open contact of power-on delay relay KT and the coil of large water flushing power-off delay relay KT2 connected in series. The said water flushing starting circuit is as follows: firstly, series circuit is composed of the normal closed contact of operating relay KM and the coil of water flushing relay KM2 connected in series; secondly, parallel circuit is composed of the normal open contact of small water flushing power-off delay relay KT1 and the normal open contact of large water flushing power-off delay relay KT2 connected in parallel; thirdly, the said water flushing starting circuit is composed of the aforesaid series circuit and the aforesaid parallel circuit connected in series. The said toilet cover position switch SP is a normally open angle switch; the said human induction switch SQ is a normally open travel switch.

The working principle of the present invention is as follows:

Under the condition that two conditions that the toilet cover is open and persons are near the toilet are met, the toilet cover position switch SP is closed and the human bodyinduction switch SQ is closed→the coil of operating relay KM is energized→the normal open contact of operating relay KM is closed and the normal closed contact of operating relay KM is disconnected→the coil of deodorization relay KM1 is energized and controls the deodorization module to start work, while the water flushing module does not work; meanwhile, the coil of power-on delay relay KT is energized, and the set time is T, that is, the time boundary point distinguishing large water flushing and small water flushing.

Small water flushing mode (i.e. water flushing after piss): the normal closed contact of power-on delay relay KT has been in closed state in time T, while its normal open contact has been in disconnected state; the coil of small water flushing power-off delay relay KT1 for timing of small water flushing is energized, while the normal open contact of small water flushing power-off delay relay KT1 has been in closed state; if people leave within time T, the human body induction switch SQ is disconnected, and the coil of operating relay KM is de-energized→the normal open contact of operating relay KM is disconnected and the normal closed contact of operating relay KM is closed→the coil of deodorization relay KM1 is de-energized and controls the deodorization module to stop working, when the coil of water flushing relay KM2 is energized and controls the water flushing module to start working. Meanwhile, the coil of power-on delay relay KT for determining the water flushing mode is de-energized, and the coil of power-off delay relay KT1 for timing of small water flushing is de-energized, and the set time is T1, that is the water flushing time of piss is T1. When the water flushing time reaches T1, the normal open contact of small water flushing power-off delay relay KT1 is disconnected, and the coil of water flushing relay KM2 is de-energized and controls the water flushing module to stop working; large water flushing mode (i.e. water flushing after faeces): when the time is T, the normal closed contact of power-on delay relay KT connected with the coil of small water flushing power-off delay relay KT1 in series is disconnected, and the normal open contact of power-on delay relay KT connected with the coil of large water flushing power-off delay relay KT2 in series is closed, while the coil of large water flushing power-off delay relay KT2 for timing of large water flushing is energized, and the normal open contact of large water flushing power-off delay relay KT2 is closed; if people leave after time T, the coil of operating relay KM is de-energized→the normal open contact of operating relay KM is disconnected, while the normal closed contact of operating relay KM is closed→the coil of deodorization relay KM1 is de-energized and controls the deodorization module to stop working, while the coil of water flushing relay KM2 is energized and controls the water flushing module to start working; meanwhile, the coil of power-on delay relay KT is de-energized, and the coil of large water flushing power-off delay relay KT2 for timing of large water flushing is de-energized, and the set time is T2, that is the water flushing time of faeces is T2. When the water flushing time reaches T2, the normal open contact of large water flushing power-off delay relay KT2 is disconnected, and the coil of water flushing relay KM2 is de-energized and controls the water flushing module to stop working.

### Embodiment 2

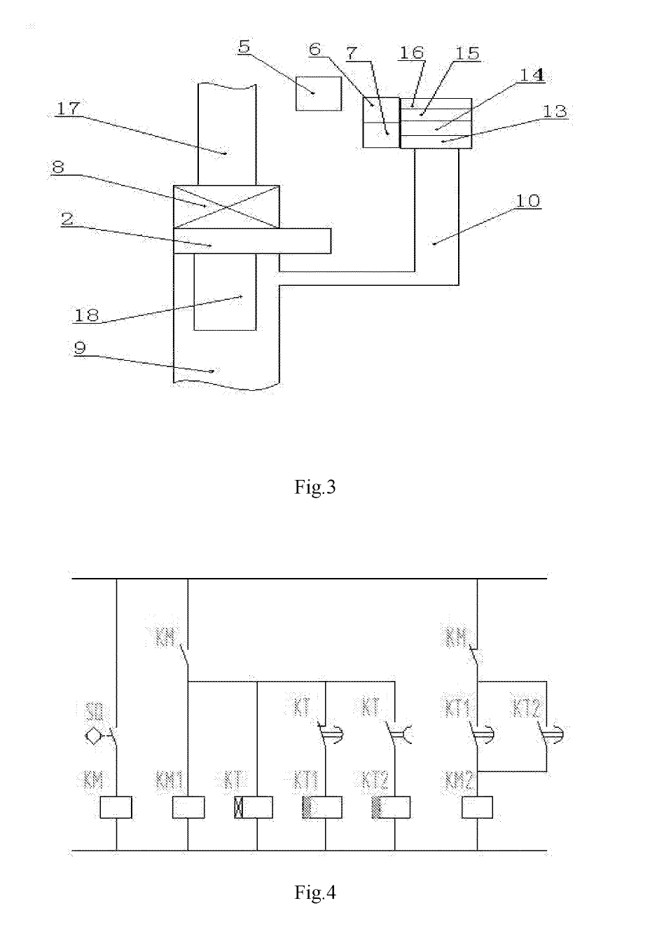

As shown in FIG. 3, an auto-cleaning device for toilet, mainly used for washdown toilet, comprising a water flushing module and a deodorization module, and further comprising a power supply module, and a control circuit which is used for automatically starting the water flushing module and the deodorization module and controlling the water flushing time. The said water flushing module comprises a water inlet pipe 17, a water flushing valve 8, a water outlet pipe 18 and a water flushing pipe 9. The lower end of the said water inlet pipe 17 is connected with the upper end of water outlet pipe 18 via the water flushing valve 8, and the lower end of water outlet 18 extends into the water flushing pipe 9 in a certain length; the position where one side of water flushing pipe 9 is higher than the bottom of water outlet pipe 18 is provided with an air exhaust pipe 10, and the air exhaust pipe 10 is connected with the deodorization module. The said power supply module comprises a storage battery 7, an electronic voltage stabilizer 6, a hydroelectric generator 2 installed below the water flushing valve 8 and an external photovoltaic cell panel 5, wherein the hydroelectric generator 2 and photovoltaic cell panel 5 are connected to the electronic voltage stabilizer 6, and connected with the storage battery 7 through the electronic voltage stabilizer 6. The said deodorization module comprises an air purification module and an air exhauster, wherein the said air purification module comprises one or the combination of active carbon 16, low temperature catalyst 14 and ozone generator 13.

As shown in FIG. 4, the said control circuit comprises a device operation starting circuit, a deodorization starting circuit, a water flushing mode selection circuit which is used for determining the water flushing time, and a water flushing starting circuit. The said device operation starting circuit is composed of human body induction switch SQ and coil of operating relay KM connected in series. The said human body induction switch SQ is a normally open travel switch, as the connecting switch of power supply module, when a person is near the human body induction switch SQ, the normal open contact will be closed→the coil of operating relay KM is energized. Other control circuits are the same as Embodiment 1, and their control principle is the same as that of Embodiment 1.

The aforesaid only enumerate a control circuit realizing automatic starting of water flushing module, deodorization module and automatic control of water flushing time. Other control circuits designed by those skilled in the art according to the present invention realizing such functions are within the protection scope of the present invention.

1. An auto-cleaning device for a toilet, comprising a water inlet module, a water flushing module and a deodorization module, wherein: further comprising a power supply module, and a control circuit which is used for automatically starting the water flushing module and the deodorization module and controlling the water flushing time; the control circuit comprises a device operation starting circuit, a deodorization starting circuit, a water flushing mode selection circuit which is used for determining the water flushing time, and a water flushing starting circuit.

2. The auto-cleaning device for toilet according to claim 1, wherein the water inlet module is arranged inside the toilet water tank, consisting of a water inlet pipe, a water replenishing pipe, and a bistable solenoid valve, wherein the upper end of water replenishing pipe is connected with the toilet water tank, while the lower end is connected with the water inlet pipe by the bistable solenoid valve.

3. The auto-cleaning device for toilet according to 1, wherein the water flushing module is arranged inside the toilet water tank, consisting of a water flushing pipe an air exhaust pipe and a water flushing valve, wherein the water flushing valve is installed inside the water flushing pipe, and one end of the air exhaust pipe is installed below the water flushing valve and connected with the water flushing pipe, while the other end is connected with the deodorization module.

4. The auto-cleaning device for toilet according to claim 3, wherein the power supply module comprises a storage battery, an electronic voltage stabilizer a hydroelectric generator installed above the bistable solenoid valve and an external photovoltaic cell panel, wherein the hydroelectric generator and photovoltaic cell panel are connected to the electronic voltage stabilizer, and connected with the storage battery through the electronic voltage stabilizer.

5. The auto-cleaning device for toilet according to claim 3, wherein the deodorization module comprises an air purification module and an air exhauster, wherein the air purification module comprises one or the combination of active carbon low temperature catalyst and ozone generator.

6. The auto-cleaning device for toilet according to claim 5, wherein the ozone generator is connected with the air purification module, while the ozone generator is connected with the toilet water tank via the pipe connected with the air pump.

7. The auto-cleaning device for toilet according to claim 1, wherein the device operation starting circuit is composed of toilet cover position switch (SP), human body induction switch (SQ) and coil of operating relay (KM) connected in series.

8. The auto-cleaning device for toilet according to claim 1, wherein the deodorization starting circuit is composed of the normal open contact of operating relay (KM) and the coil of deodorization relay (KM1) connected in series.

9. The auto-cleaning device for toilet according to claim 1, wherein the water flushing mode selection circuit is connected with the coil of deodorization relay (KM1) in parallel, consisting of three parallel branches, the first branch is the coil of power-on delay relay (KT) used for determining water flushing mode; the second branch is composed of the normal closed contact of power-on delay relay (KT) and the coil of small water flushing power-off delay relay (KT1) connected in series; the third branch is composed of the normal open contact of power-on delay relay (KT) and the coil of large water flushing power-off delay relay (KT2) connected in series.

10. The auto-cleaning device for toilet according to claim 1, wherein the water flushing starting circuit is as follows: firstly, series circuit is composed of the normal closed contact of operating relay (KM) and the coil of water flushing relay (KM2) connected in series; secondly, parallel circuit is composed of the normal open contact of small water flushing power-off delay relay (KT1) and the normal open contact of large water flushing power-off delay relay (KT2) connected in parallel; thirdly, the water flushing starting circuit is composed of the aforesaid series circuit and the parallel circuit connected in series.

11. The auto-cleaning device for toilet according to claim 7, wherein the toilet cover position switch (SP) is a normally open angle switch; the human body induction switch (SQ) is a normally open travel switch.
